(19) United States
(12) Patent Application Publication
(10) Pub. No.: US 2024/0257141 A1
(43) Pub. Date: Aug. 1, 2024

(54) A SYSTEM AND METHOD FOR FACILITATING RULE-BASED PARTIALLY ONLINE AND OFFLINE PAYMENT TRANSACTIONS

(71) Applicant: NATIONAL PAYMENTS CORPORATION OF INDIA, Mumbai (IN)

(72) Inventors: Arif KHAN, Mumbai (IN); Ashutosh DUBEY, Mumbai (IN); Nishant GAURAV, Mumbai (IN); Sateesh PALAGIRI, Nanakaramguda (IN)

(73) Assignee: NATIONAL PAYMENTS CORPORATION OF INDIA, Mumbai (IN)

(21) Appl. No.: 18/563,417

(22) PCT Filed: May 23, 2022
(86) PCT No.: PCT/IB2022/054791

§ 371 Date: Nov. 22, 2023

(30) Foreign Application Priority Data
May 25, 2021 (IN) 202121023338

(51) Int. Cl. G06Q 20/40; G06Q 20/36; G06Q 20/38

(52) U.S. Cl. CPC G06Q 20/405; G06Q 20/3672; G06Q 20/3829; G06Q 20/4012; G06Q 20/40145

(57) ABSTRACT

The present disclosure discloses a system (100) and method (200) for facilitating registered users to perform rule-based partially online and offline payment transactions. A PSP tool (20), installed in an electronic device (10) associated with a registered user, executes a trusted application (104) in a secured storage area of the device (10). The trusted application (104), the PSP tool (20), and the PSP server (30) are enabled to communicate with an authentication engine (108) and a plurality of banking system servers (40,50) via an electronic switch (106) to facilitate the registered user to enroll and create (204a) a Unified-payments-Interface (UPI) lite account; load money (204b) into the created account from a registered financial account, wherein the money is stored as a balance value in the secured storage area; and utilize the balance value (204c) for performing the partially online and offline payment transactions without hitting the banking system servers (40,50).

### FIELD

The present disclosure generally relates to payment systems. More particularly, the present disclosure relates to a system and method for facilitating rule-based partially online and offline payment transactions.

### Definitions

As used in the present disclosure, the following terms are generally intended to have the meaning as set forth below, except to the extent that the context in which they are used indicate otherwise.

Registered user—The term ‘registered user’ hereinafter refers to a person having a financial/bank account and using the UPI-based electronic payment system for carrying out electronic payment transactions. To use the UPI-based electronic payment system, the person has a UPI ID/Virtual Payment Address lined to the financial/bank account. The registered user can be a payer i.e. a person who wants to send/pay money, or can be a payee i.e. a person who receives/collects money using the UPI-based electronic payment system.

Electronic device/User device/Mobile device—The terms ‘electronic device’, ‘user device’, and ‘Mobile device’ hereinafter refer to a device, used by the registered user of the present disclosure, wherein the user device includes but is not limited to a mobile phone, a laptop, a tablet, an iPad, a PDA, a notebook, a net book, a smart device, a smart phone, a personal computer, a handheld device and the like.

Payment transactions—The term ‘payment transactions’ hereinafter refers to financial as well as non-financial transactions. The financial transactions comprise collect/pull request and pay/push request based, person-to-person (P2P), person-to-account (P2A), and person-to-merchant (P2M) payment transactions. The non-financial transactions include, but are not limited to mobile banking registration, generation of one-time password (OTP), checking balance, setting or changing PIN, logging a complaint, and checking transaction status.

Payment Service Provider—The term ‘Payment Service Provider (PSP)’ hereinafter refers to an internet bank, a payments bank, a Prepaid Payment Instrument (PPI), or any other centrally and/or government-regulated entity that is allowed to acquire customers and provide payment (credit/debit) services to the customers (individuals or entities). The PSP provides respective payment tools/applications that can be accessed by the registered users on their user devices to carry out payment transactions. The PSP provides a tool for the electronic processing of financial and non-financial transactions.

Global Identifier or Virtual Payment Address or UPI ID—The terms Global Identifier (GI) or Virtual Payment Address (VPA/UPI ID) or UPI (Unified Payment Interface) ID hereinafter refer to a unique identifier, associated with the financial/bank account of the registered user. The unique Global identifier (GI) or virtual Payment address (VPA/UPI ID) is used to carry out payment transactions. GI can include a mobile number, an Aadhaar number, a bank account number, or any other identifier that can uniquely and securely identify the registered user of the present disclosure. VPA/UPI ID can also be created by a registered user for carrying out payment transactions. The term ‘Global identifier’ as used herein is meant to include GI, VPA as well as UPI ID.

Payment Service Provider tool—The term ‘Payment Service Provider tool (PSP tool)’ hereinafter refers to an application or a tool provided by each PSP. The PSP tool may be provided on a web portal or play store and/or mobile web or through other means to provide registered users an interface with the UPI through the PSP.

Unified Payment Interface (UPI) server/authentication engine—The term ‘UPI server’/‘authentication engine’ hereinafter refers to a central system that facilitates interaction between a plurality of PSPs and banks (i.e., banking system servers) for carrying out financial and non-financial transactions.

Common library or Trusted application—The terms “common library” or “trusted application” hereinafter refer to an authorized security software which is executed in a Secure Environment in a device and can be executed only by enforcing protected authenticated code, confidentiality, authenticity, privacy, system integrity, and data access rights. It is an enhanced version of PIN encryption solution which enables Storing a Value called “store value” or “balance value” therein. This amount will have an underlying which will be safeguarded by the user's bank. The common library also stores sensitive credentials like PIN, passwords, biometrics etc. Authentication details are captured and encrypted inside the common library. The PSP does not store the encrypted credentials within any permanent storage. The PSP does not capture the authentication credentials of the issuer outside the common library.

Store Value or Balance value—The terms ‘Store Value’ or ‘balance value’ hereinafter refer to a virtual form of an amount whose underlying resides with the user's bank. The store/balance value is similar to a token or digital asset and has information about the value of the asset, the ownership of the asset, the issuer, and a merkle tree of last few transactions. The store value enables “good fund transactions/Pre-approved transactions” from the common library.

Authentication Engine—The term ‘authentication engine’ hereinafter refers to a component within the central system which will verify the integrity of the partially online and offline transactions and provide a response to the common library for allowing further such transactions. The authorization engine will also store a copy of the latest balances in the event of user scenarios such as the recovery of balance due to device damage/lost/change.

Reference number—The term “reference number” hereinafter refers to an instance of a lite Service account creation at the authentication engine which denotes a unique store value present in the secure storage area.

Cryptogram—The term ‘Cryptogram’ hereinafter refers to a puzzle that consists of a short piece of encrypted text.

Authorization Request Cryptogram (ARQC)—ARQC refers to a hash generated by the common library using private keys to communicate the transaction details to the authentication engine. Without ARQC, the transactions cannot be initiated.

Authorization Response Cryptogram (ARPC)—ARPC is a response code generated by the authentication engine upon receiving and verifying the ARQC. The authentication engine decrypts the transaction using public keys, verifies the details sent by the common library, and generates the ARPC upon successful verification.

Partially Online Transaction—The expression ‘Partially online transaction’ hereinafter refers to rule-based, low value transactions performed using the system and method of the present disclosure without hitting the bank servers.

Online Transaction—The expression ‘online transaction’ hereinafter refers to UPI-based transactions performed using PSP tools and validated using two-factor authentication with the help of issuer banking system servers.

Offline transaction—The expression ‘offline transaction’ hereinafter refers to rule-based transactions performed without any data connection or any communication with PSP servers.

Secure Element (SE)—The term ‘Secure Element’ or ‘SE’ refers to a microprocessor chip that can store sensitive data and run secure applications such as payment applications. The SE acts as a vault, protecting the applications and data stored inside from malware attacks that are typical in the host (i.e. the device operating system).

Trusted Execution Environment (TEE)—The term ‘trusted execution environment’ or ‘TEE’ is a secure area of the main processor which guarantees the code and data loaded inside to be protected with respect to confidentiality and integrity.

Communication means—The term “communication means” hereinafter refers to a means for transmitting and receiving electronic data. The communication means may include, for example, the Internet, the World Wide Web, an intranet, cable (including fiber optic cable), magnetic communications, electromagnetic communications (including RF, microwave, and infrared communications), and electronic communications. Wireless communication means can support various wireless communication network protocols and technologies such as Near Field Communication (NFC), Wi-Fi, Bluetooth, 4G Long Term Evolution (LTE), Code Division Multiplexing Access (CDMA), Universal Mobile Telecommunication System (UMTS) and Global System for Mobile Telecommunication (GSM).

### BACKGROUND

The background information herein below relates to the present disclosure but is not necessarily prior art.

In the last few years, Unified Payment Interface (UPI) has emerged as one of the prime choices for customers for performing retail payments. The ability to perform payments through smartphones with 2-3 clicks has provided an enhanced experience to the end-users. However, the number of UPI-based payment transactions has increased exponentially, which has led to an increase in the load of the issuer switch and servers of the banks and Payment Service Providers (PSPs). Further, the infrastructure at PSPs to support such a large number of transactions and provide reliability in terms of success rate is degrading in the last few months.

In addition to the above, conventional mobile-based payment transactions require users to provide sensitive information such as UPI PIN, password, or MPIN for carrying out small value transactions. This increases the time required for processing low value payment transactions and also leads to online PIN verification for all the transactions at the bank, thereby putting a heavy load on the bank servers, which is not desired.

To address the aforementioned problems of the conventional payment solutions, there is a need for a system and method that facilitates rule-based, low-value, partially online and offline payment transactions without hitting the bank servers.

### Objects

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a system and method for facilitating rule-based partially online and offline payment transactions.

Another object of the present disclosure is to provide a system for facilitating small value transactions without requiring the users to expose sensitive information such as PINs or passwords.

Still another object of the present disclosure is to provide a system for facilitating rule-based partially online and offline payment transactions that reduces the processing load on issuer switch, payment service providers, and banking system servers.

Yet another object of the present disclosure is to provide a system that facilitates rule-based, small value transactions without hitting the bank servers.

Still another object of the present disclosure is to provide a payment system for facilitating partially online and offline payments that is highly secure.

Yet another object of the present disclosure is to provide a system that enables registered users to carry out payment transactions in one click.

Other objects and advantages of the present disclosure will be more apparent from the following description when read in conjunction with the accompanying figures, which are not intended to limit the scope of the present disclosure.

### SUMMARY

The present disclosure envisages a method for facilitating registered users to perform rule-based partially online and offline payment transactions. Each of the registered users has one or more payment service provider (PSP) tools installed on their electronic devices. Each PSP tool is hosted by a PSP server. Each of the registered users has a financial account linked with a unique multi-character PIN and a global identifier. The method comprises the following steps—
executing, by a PSP tool installed in an electronic device associated with a registered user, a trusted application in a secured storage area of the electronic device;
enabling, via a central electronic switch, the trusted application, the PSP tool, and the PSP server to communicate with an authentication engine and a plurality of banking system servers to enable the registered user to enroll and create a Unified payments Interface (UPI) lite account for performing the rule-based partially online and offline payment transactions; load money into the created UPI lite account from a registered financial account, wherein the value of money loaded into the UPI lite account is stored as a balance value in the secured storage area; and utilize the balance value for performing the partially online and offline payment transactions without hitting the banking system servers.

In an embodiment, the step of enabling the registered user to enroll and create the UPI lite account for performing the rule-based partially online and offline payment transactions comprises—
i. receiving, by the PSP tool, a service enablement command from the registered user via the PSP tool interface, the service enablement command comprising the details of a financial account to be enabled for performing partially online and offline transactions;
ii. generating, by the PSP tool, a request for fetching public key upon receiving the service enablement command and sending the generated public key fetching request to the trusted application;
iii. generating, by the trusted application, a private(Ps)-public(Pk) key pair within the secure storage area of the electronic device upon receiving the public key fetching request from the PSP tool;
iv. sending, by the trusted application, the public key from the generated private-public key pair to the PSP tool;
v. generating, by the PSP tool, a key list request upon receiving the public key, the key list request comprising the public key;
vi. transmitting, by the PSP tool, the generated key list request to the electronic switch via the PSP server associated with the PSP tool;
vii. routing, by the electronic switch, the key list request received from the PSP server to the authentication engine;
viii. opening, by the authentication engine, the UPI lite account for the registered user by generating a Digital Certificate(DC-Pk) using the public key and updating a service enablement record with a unique lite account number, wherein the Digital-certificate(Pk) and the public key are stored by the authentication engine for authenticating future partially online or offline transactions initiated from the electronic device;
ix. generating, by the authentication engine, a key list success response upon successfully opening the UPI lite account and storing the public key; and
x. communicating, by the authentication engine, the key list success response to the PSP tool via the electronic switch and the PSP server to notify the registered user about the service enablement success for the respective financial account.

In an embodiment, the step of enabling the registered user to load money into the created UPI lite account from the registered financial account:
i. generating, by the PSP tool, a PIN and amount entry prompt on the PSP tool interface, to retrieve the multi-character PIN and a top-up amount from the registered user to load the amount into the created UPI lite account;
ii. receiving, by the PSP tool, the multi-character PIN, and the top-up amount via the PSP tool interface;
iii. prompting, by the trusted application, the registered user to perform a first-level verification by implementing a device fingerprint scan;
iv. creating, by the trusted application, a first credential block comprising the multi-character PIN and a second credential block comprising a first authorization request cryptogram (ARQC) after performing a plurality of pre-defined checks;
v. receiving, by the PSP tool, the generated first and second credential blocks from the trusted application;
vi. initiating, by the PSP tool, a load money request to the PSP server, the load money request comprising the first and second credential blocks;
vii. sending, by the PSP server, the load money request to the authentication engine via the electronic switch;
viii. validating, by the authentication engine, the service enablement record and the first ARQC, upon receiving the load money request;
ix. forwarding, by the electronic switch, the load money request to an issuer banking system server associated with the financial account of the registered user;
x. validating, by the issuer banking system server, the multi-character PIN of the registered user;
xi. debiting, by the issuer banking system server, the financial account of the registered with the top-up amount and crediting the top-up amount into a pool account upon successful validation;
xii. sending, by the issuer banking system server, a load money success response to the authentication engine via the electronic switch, upon successfully crediting the pool account with the top-up amount;
xiii. updating, by the authentication engine, the UPI lite account with a balance value based on the top-up amount and generating a first authorization response cryptogram (ARPC) and an update success response;
xiv. sending, by the authentication engine, the first ARPC and the update success response to the PSP server via the electronic switch;
xv. sending, by the PSP server, the first ARPC to the trusted application via the PSP tool;
xvi. verifying and updating, by the trusted application, the balance value in the secure storage area of the electronic device; and
xvii. displaying, by the PSP tool, the updated balance value to the registered user via the PSP tool interface.

In an embodiment, the step of enabling the registered user to utilize the balance value for performing the partially online transactions without hitting the banking system servers comprises:
i. enabling, by the PSP tool, the registered user to initiate a payment transaction, wherein the payment transaction is initiated by the registered user by providing transaction details, the transaction details including a payee's global identifier and a transaction amount;
ii. triggering, by the PSP tool, the trusted application upon payment transaction initiation to cause the trusted application to generate and return a second ARQC after performing a plurality of pre-defined checks, the second ARQC comprising the transaction details and the balance value extracted from the secure storage area;
iii. sending, by the PSP tool, the second ARQC to the PSP server;
iv. initiating, by the PSP server, a payment request to the electronic switch upon receiving the second ARQC;
v. initiating, by the electronic switch, a global identifier translation request to the payee PSP server of the payment transaction to obtain financial account details of the payee;
vi. initiating, by the electronic switch, a validation request to the authentication engine by sending the second ARQC to the authentication engine;
vii. validating, by the authentication engine, the ARQC;
viii. debiting, by the authentication engine, the transaction amount from the balance value on successful validation and generating a second ARPC in response;
ix. sending, by the authentication engine, the generated second ARPC to the electronic switch;
x. initiating, by the electronic switch, a credit request to the payee's banking system server based on the translated global identifier;
xi. sending, by the electronic switch, a credit success response along with the second ARPC to the payer's PSP server upon successfully crediting the payee account with the transaction amount;
xii. sending, by the PSP server, the credit success response with the second ARPC to the PSP tool;
xiii. sending, by the PSP server, the credit success response and the ARPC to the trusted application; and
xiv. updating, by the trusted application, the balance value stored in the secure storage area based on the ARPC.

In an embodiment, the method further comprises the step of enabling, by the PSP tool, the registered user to disable the UPI lite account, the step comprising the following sub-steps:
i. enabling, by the PSP tool, the registered user to initiate the disablement of the UPI lite account;
ii. triggering, by the PSP tool, the trusted application upon initiation of disablement to cause the trusted application to generate and return a third ARQC after performing a plurality of pre-defined checks, the third ARQC comprising the registered user's financial account details under payee and the registered user's lite account number under payer;
iii. sending, by the PSP tool, the third ARQC to the PSP server;
xi. initiating, by the PSP server, a payment request to the electronic switch upon receiving the third ARQC, the payment request comprising the third ARQC;
xii. forwarding, by the electronic switch, the payment request to the authentication engine;
xiii. validating, by the authentication engine, the received ARQC;
xiv. debiting, by the authentication engine, the balance value on successful validation and generating a third ARPC in response;
xv. sending, by the authentication engine, the generated third ARPC to the electronic switch;
xvi. sending, by the electronic switch, a credit request to the issuer banking system server to credit the financial account of the registered user with the balance value;
xvii. receiving, by the electronic switch, a credit success response from the issuer banking system server, and forwarding the credit success response and the third ARPC to the PSP server;
xviii. sending, by the PSP server, the credit success response and the ARPC to the trusted application via the PSP tool; and
xix. clearing, by the trusted application, the balance value stored in the secure storage area upon receiving the ARPC.

In an embodiment, the step of disabling the UPI lite account fails when:
i. there is a timeout at the issuer banking system server;
ii. decline by the issuer banking system server; and
iii. there is a message drop between the PSP server and the electronic switch, thereby hampering the transmission of the third ARPC and the credit success response to the PSP server.

In an embodiment, the step of enabling the registered user to utilize the balance value for performing the offline transaction comprises:
i. enabling, by the PSP tool, the registered user to initiate an offline payment transaction, wherein the offline payment transaction is initiated by the registered user by establishing a communication channel between the electronic device and a payee device to obtain the transaction details, the transaction details including a payee's global identifier and a transaction amount;
iv. generating, by the trusted application, an offline signature using an offline data authentication technique; and
v. sending, by the trusted application, the generated offline signature along with the digital certificate, to the PSP tool;
vi. sending, by the PSP tool, the offline signature to the payee device and the PSP server;
vii. authenticating, by the payee device and the PSP server, the PSP tool based on the available balance value in the secured storage area, the offline signature, and the digital certificate;
viii. debiting, by the PSP tool, the required amount from the balance value post successful authentication; and
ix. sending, by the payee device, an advice to the authentication engine to update the balance value.

In an embodiment, the plurality of pre-defined checks includes one or more of the following:
a determination as to whether the electronic device is rooted or not;
a determination as to whether the electronic device supports the secure storage area or not;
a determination as to whether or not the key attestation is valid; and
a determination as to whether or not one or more transaction parameters satisfy one or more pre-defined criteria.

In an embodiment, the transaction parameters are selected from the group consisting of the balance value, a count of the partially online transactions, a count of offline transactions, the transaction amount associated with the partially online transaction, the transaction amount associated with the offline transaction, a total amount associated with the partially online transactions, and a total amount associated with the offline transactions.

In an embodiment, the determination as to whether or not one or more transaction parameters satisfy the one or more pre-defined criteria include:
i. whether the transaction amount is less than or equal to a maximum value of the transaction amount for a partially online transaction;
ii. whether the transaction amount is less than or equal to a maximum value of the transaction amount for an offline transaction;
iii. whether the transaction amount is less than or equal to the balance value in the UPI lite account;
iv. whether a count of the partially online transaction is less than a pre-defined online transaction count limit;
v. whether a count of the offline transaction is less than a pre-defined offline transaction count limit;
vi. whether the count of the offline transaction is less than or equal to a maximum number of offline consecutive transactions that are allowed; and
vii. whether a total amount of offline transactions is less than or equal to a pre-defined maximum offline transaction amount limit.

In an embodiment, the first, second, and the third ARQC include one or more of the following:
a. the public key of the device stored in the secured storage area;
b. a transaction block comprising one or more of the transaction parameters encrypted with a random AES key, the transaction block being further encrypted with another AES key that resides in the secure storage area, the transaction parameters comprising one or more of the following information:
   i. the transaction amount, transaction date, transaction time, and payee global identifier;
   ii. a random number;
   iii. customer verification result;
   iv. balance value; and
   v. transaction counter, Public Key exponent (asymmetric), transaction type, and balance limit.

In an embodiment, the trusted application is device-binding and is defined based on the parameters selected from the group consisting of an application identifier, a device identifier of the registered user, mobile number of the registered user, IFSC of the issuer banking system server, and the financial account number.

In an embodiment, the PSP tool is configured to detect a tamper event and is further configured to cause the automatic and immediate erasure of the information contained in the PSP tool upon detection of the tamper event.

The present disclosure further envisages a system for facilitating registered users to perform rule-based partially online and offline payment transactions.

### BRIEF DESCRIPTION OF THE ACCOMPANYING DRAWING

A system for facilitating registered users to perform rule-based partially online and offline payment transactions and a method thereof of the present disclosure will now be described with the help of the accompanying drawing, in which:

FIG. 1 illustrates a block diagram of a system for facilitating rule-based partially online and offline payment transactions, in accordance with the present disclosure;

FIG. 2 illustrates a flow diagram of a method for facilitating rule-based partially online and offline payment transactions, in accordance with the present disclosure;

FIG. 3 illustrates a flow chart of an enablement process of the method of FIG. 2, in accordance with the present disclosure;

FIG. 4A illustrates exemplary PSP tool screens depicting the flow of loading money in the UPI lite account, in accordance with the present disclosure;

FIG. 4B illustrates a flow chart of the money loading process of the method of FIG. 2, in accordance with the present disclosure;

FIG. 5 illustrates a flow chart of enabling the registered user to perform partially online transactions of the method of FIG. 2, in accordance with the present disclosure;

FIG. 6 illustrates a flow chart of enabling the registered user to disable the UPI lite account of the method of FIG. 2, in accordance with the present disclosure; and

FIG. 7 illustrates a flow chart of enabling the registered user to perform offline transactions of the method of FIG. 2, in accordance with the present disclosure.

### LIST OF REFERENCE NUMERALS

100—System
10—Electronic device/Mobile device/User device
20—Payment System Provider tool (PSP tool)
30—Payment System Provider (PSP)
40—Issuer banking system server/Issuer CBS/Remitter CBS
50—Beneficiary banking system server/Beneficiary CBS
102—Secured storage area (SE/TEE)
104—Trusted application
106—Central electronic switch
108—Authentication engine

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “including,” and “having,” are open ended transitional phrases and therefore specify the presence of stated features, integers, steps, operations, elements and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “engaged to,” “connected to,” or “coupled to” another element, it may be directly engaged, connected or coupled to the other element. As used herein, the term “and/or” includes any and all combinations of one or more of the associated listed elements.

In the last few years, Unified Payment Interface (UPI) has emerged as one of the prime choices for customers for performing retail payments. The ability to perform payments through smartphones with 2-3 clicks has provided an enhanced experience to the end-users. However, the number of UPI-based payment transactions has increased exponentially, which has led to an increase in the processing load on the issuer switch and servers of the banks and Payment Service Providers (PSPs). Further, the infrastructure at PSPs to support such a large number of transactions and provide reliability in terms of success rate is degrading in the last few months.

In addition to the above, conventional mobile-based payment transactions require users to provide sensitive information such as UPI PIN, MPIN, or password for carrying out small value transactions. This increases the time required for processing low value payment transactions, which is not desired.

In order to address the aforementioned problems, the present disclosure envisages a system (hereinafter referred to as “system 100”) and method (hereinafter referred to as “method 200”) for facilitating rule-based partially online and offline payment transactions between registered users using Payment System Provider (PSP) tools.

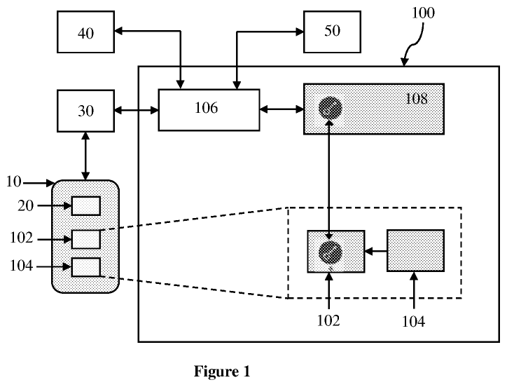

Referring to FIG. 1, the system 100 comprises a trusted application 104, a central electronic switch 106, and an authentication engine 108. Each of the registered users has one or more PSP tools 20 installed on their electronic devices 10. Each of the PSP tools 20 is hosted by a PSP server 30. The registered users have a financial account linked with a unique multi-character PIN and a global identifier (e.g., Mobile number, UPI ID, Virtual Payment Address). The PSP tools 20 are configured to run/execute the trusted application 104 in a secured storage area 102 within the electronic device 10. The secured storage area 102 corresponds to a Secure Element (SE) or a Trusted Execution Environment (TEE) of the electronic device 10. The electronic switch 106 is coupled to the PSP servers 30, a plurality of banking system servers (40,50), and the authentication engine 108. The electronic switch 106 is configured to facilitate communication of the trusted application 104, the PSP tool 20, and the PSP server 30 with the authentication engine 108 and a plurality of banking system servers (40,50), directly or indirectly, to enable the registered user to execute multiple user journeys. This includes enabling the registered user to—enroll and create a UPI lite account for performing the rule-based partially online and offline payment transactions; load money into the created UPI lite account from a registered financial account, wherein the value of money loaded into the UPI lite account is stored as a balance value in the secured storage area of the electronic device 10; and utilize the balance value for performing the partially online and offline payment transactions without hitting the banking system servers (40,50). The user journeys may also include non-financial transactions such as balance inquiry, and the like.

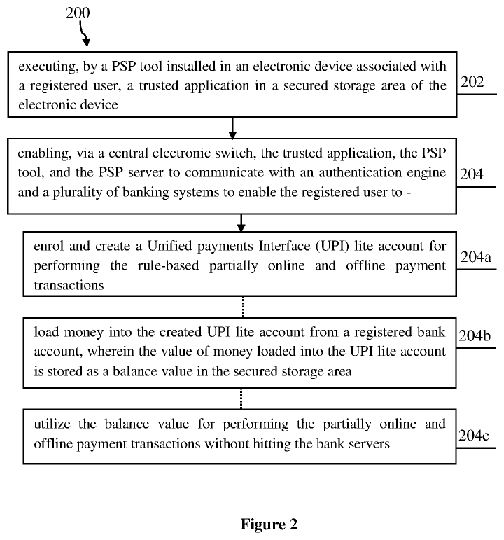

Accordingly, FIG. 2 illustrates the method 200 for facilitating the registered users to perform the rule-based partially online and offline payments. Each of the registered users has one or more payment service provider (PSP) tools 20 installed on their electronic devices 10, each PSP tool 20 is hosted by a PSP server 30. The registered users have a financial account linked with a unique multi-character PIN and a global identifier. The method 200 comprises the following steps:

At step 202, a PSP tool 20 installed in an electronic device 10 associated with a registered user executes a trusted application 104 in a secured storage area of the electronic device 10.

At step 204, the trusted application 104, PSP tool 20, and the PSP server 30 are enabled, via a central electronic switch 106, to communicate with an authentication engine 108 and a plurality of banking system servers (40,50) to enable the registered user to—
enroll and create 204a a Unified payments Interface (UPI) lite account for performing the rule-based partially online and offline payment transactions;
load money 204b into the created UPI lite account from a registered financial account, wherein the value of money loaded into the UPI lite account is stored as a balance value in the secured storage area of the electronic device 10; and
utilize the balance value 204c for performing the partially online and offline payment transactions without hitting the banking system servers (40,50), wherein the balance value is like a token or digital asset and has information about the value of the asset, the ownership of the asset, the issuer, and a merkle tree of last few transactions.

The system 100 facilitates a registered user to enroll with the authentication engine 108 and create the UPI lite account. The UPI lite account enables the registered user to perform small value, partially online and offline payment transactions with other registered users and merchants. The PSP tools 20 used by the registered users may already have one or more accounts added for enabling the registered users to carry out online payment transactions. The term ‘registered users’ used herein refers to the users who are already onboarded with the UPI server/authentication engine 108 for carrying out (fully) online UPI-based payment transactions. Based on the configuration of the associated issuers, the PSP servers 30 hosting the PSP tools 20 can prompt the users to set up the UPI account for carrying out partially online and offline transactions also.

For example, if a registered user is enrolled with multiple banks (A, B, C) for carrying out fully online UPI-based transactions and bank “A” supports the creation of the UPI lite account, the PSP server 30 may display an “Enable UPI account” option below the bank name ‘A’ on the display screen of the device 10 via the PSP tool interface. On clicking “Enable UPI account”, the PSP tool sends a fetch public key request to the trusted application 104. In response, the trusted application 104 generates a Private(Ps)-Public(Pk) key pair directly inside the secured storage area 102 like TEE of the electronic device 10. The generated public key is sent to the authentication engine 108 by the PSP tool 20 via the PSP server 30 and the electronic switch 106. The authentication engine 108 signs the Public Key(Pk) along with some other details like device ID, account No., mobile number, global identifier etc. to generate a Digital Certificate(DC-Pk) (also referred to as “standard transaction certificate/STC”). The authentication engine 108 creates a unique UPI lite account number and opens the corresponding UPI lite account for the registered user. This Digital-certificate(DC-Pk) is stored by the authentication engine 108 as well as the trusted application 104 for authenticating future transactions from this device 10.

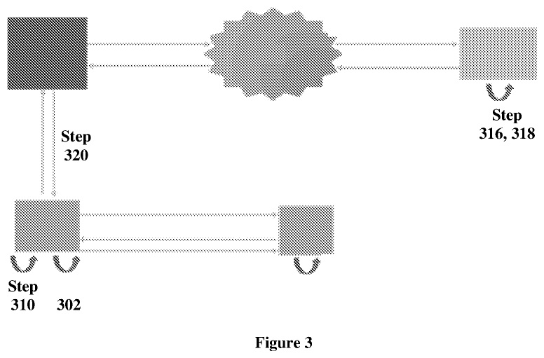

In an embodiment, referring to FIG. 3, the step of enabling the registered user to enroll and create 204a the UPI lite account for performing the rule-based partially online and offline payment transactions comprises:

At step receiving 302, the PSP tool 20 receives a service enablement command from the registered user via the PSP tool interface, the service enablement command comprising the details of a financial account to be enabled for performing partially online and offline transactions. In other words, the registered user is enabled to select a financial account to be enabled from one or more pre-existing financial accounts, via the PSP tool interface, to carry out payment partially online and offline payment transactions.

At step 304, the PSP tool 20 generates a request for fetching public key upon receiving the service enablement command and sends the generated public key fetching request to the trusted application 104.

At step 306, the trusted application 104 generates a private(Ps)-public(Pk) key pair within the secure storage area of the electronic device 10 upon receiving the public key fetching request from the PSP tool.

At step 308, the trusted application 104 sends the public key (Ps) from the generated private-public key pair (Ps-Pk) to the PSP tool 20.

At step 310, the PSP tool 20 generates a key list request upon receiving the public key, wherein the key list request comprises the generated public key (Pk).

At step 312, the PSP tool 20 transmits the generated key list request to the electronic switch 106 via the PSP server 30 associated with the PSP tool 20.

At step 314, the electronic switch 106 routes the key list request received from the PSP server 30 to the authentication engine 108.

At step 316, the authentication engine 108 opens the UPI lite account for the registered user by generating a Digital Certificate(DC-Pk) using the public key and updating a service enablement record with a unique lite account number, wherein the service enablement record indicates opening of the UPI lite account for the registered user and the unique lite account number is a unique account number associated with the UPI lite account. The digital certificate contains the public key embedded therein with additional information describing the owner i.e., the registered user associated with the public key. The additional information may include, but is not limited to, name, postal address, device ID, account No., mobile number, global identifier, and e-mail address of the registered user. The Digital-certificate(Pk) and the public key are stored by the authentication engine 108 and the trusted application 104 for authenticating future partially online or offline transactions initiated from the electronic device 10. The Digital-certificate(Pk) and the public key may be stored in-house or in a separate repository or on a cloud server.

At step 318, the authentication engine 108 generates a key list success response upon successfully opening the UPI lite account and storing the public key.

At step 320, the authentication engine 108 communicates the key list success response to the PSP tool 20 via the electronic switch 106 and the PSP server 30 to notify the registered user about the service enablement success for the respective financial account.

Exemplary pseudo codes depicting the functions of the PSP tool 20, the trusted application 104, and the authentication engine 108 are as follows—

```
PSP tool -
Read (service enablement command);
Do
  {
  Generate public key fetching request;
  Send public key fetching request to the trusted application;
  Do
    {
    generate a key list request;
    transmit the generated key list request to the authentication engine via the PSP
    server and the electronic switch;
    }
  while (reading public key from the trusted application)
  }
Trusted application or common library -
Do
  {
  Generate a private(Ps)-public(Pk) key pair within the secure storage area;
  Send public key to the PSP tool;
  }
While (reading public key fetching request)
Authentication Engine -
Do
  {
  receive key list request;
  open a UPI lite account for the registered user by generating a Digital Certificate(DC-
  Pk) using the public key within the key list request;
  update a service enablement record with a unique lite account number;
  generate a key list success response;
  send the key list success response to the PSP tool 20 via the electronic switch and the
  PSP server to notify the registered user about the service enablement success for the
  respective financial account.
  }
```

The step of enabling the registered user to enroll and create the UPI lite account for performing the rule-based payment transactions fails when there is a message dropout between the PSP server 30 and the electronic switch 106.

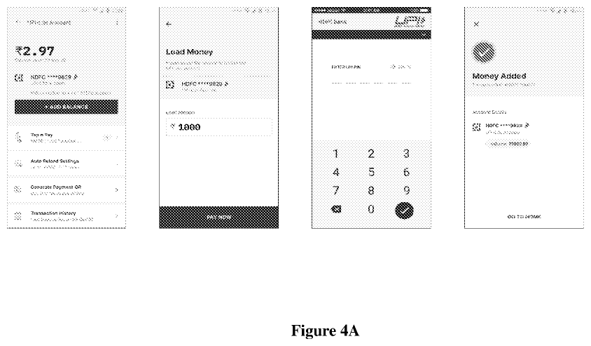

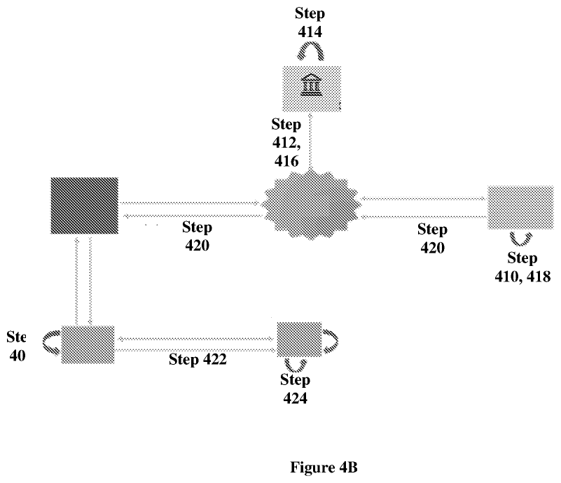

The registered user can transfer money to the UPI lite account at any point in time with the help of the PSP tool 20. In a load money transaction, the registered user is required to enter the multi-character PIN as shown in FIG. 4A. The money may be loaded into the UPI lite account only from the financial account(s) selected for enablement during the enrolment process.

The authentication engine 108 is configured to store a list of enrolled registered users (i.e. user names or unique reference numbers associated with user accounts), and the balance value, the pre-defined parameters, the public key, and digital certificate associated with each of the registered users. Upon receiving a load money request from a registered user, the authentication engine 108 updates the balance value associated with the registered user after the multi-character PIN of the registered user is successfully validated by the issuer banking system server 40.

In an embodiment, referring to FIG. 4B, the step of enabling the registered user to load money 204b into the created UPI lite account from the registered financial account comprises:

At step 402, the PSP tool 20 generates a PIN and amount entry prompt on the PSP tool interface to retrieve the multi-character PIN and a top-up amount from the registered user to load the amount into the created UPI lite account. The PSP tool 20 receives the multi-character PIN and the top-up amount via the PSP tool interface. The top-up amount and the multi-character PIN are sent to the trusted application 104. Upon receiving the top-up amount and the multi-character PIN, the trusted application 104 prompts the registered user to perform a first-level verification. The first-level verification may be performed, for e.g., by entering a pre-set device lock PIN or password, by inputting a pre-set screen lock pattern, or by implementing a device fingerprint scan.

At step 404, the trusted application 104 performs a plurality of pre-defined checks. The pre-defined checks include, but are not limited to, a determination as to whether the electronic device is rooted or not, a determination as to whether the electronic device supports the secure storage area or not, a determination as to whether or not the key attestation is valid, and a determination as to whether or not one or more transaction parameters satisfy one or more pre-defined criteria. For instance, the transaction parameter can be the current balance value, the maximum allowable balance value, or the minimum value for adding funds.

Accordingly, the pre-defined criterion can be whether the top-up amount plus the balance value is less than or equal to the maximum allowable balance value. Alternatively, the pre-defined criterion can be whether the top-up amount is greater than the minimum value for adding funds. In an example, if the maximum allowable balance value is Rs. 2000, the trusted application 104 checks if the top-up amount when added to the balance value is less than or equal to Rs. 2000. Upon successful checks, the trusted application 104 creates a first credential block comprising the multi-character PIN and a second credential block comprising a first authorization request cryptogram (ARQC). The PSP tool 20 receives the generated first and second credential blocks from the trusted application 104. The first ARQC comprises transaction details and results of the parameter checks encrypted with a random AES key, wherein the AES key is encrypted with the private key (Ps). The transaction details comprise the global identifier of the registered user as payer details, the UPI lite account number as payee details, the top-up amount as the transaction amount, and the transaction date and transaction time.

At step 406, the PSP tool 20 initiates a load money request to the PSP server 30. The load money request comprises the first and second credential blocks.

At step 408, the PSP server 30 sends the load money request to the authentication engine 108 via the electronic switch 106.

At step 410, the authentication engine 108 validates the service enablement record and the first ARQC, upon receiving the load money request. The validation involves validating the first ARQC using the digital certificate corresponding to the registered user. This involves decrypting the first ARQC using the public key and matching the decrypted block (containing AES encrypted transaction details and results of the parameter checks) with the details stored in the authentication engine 108.

At step 412, the electronic switch 106 forwards the load money request to an issuer banking system server 40 associated with the financial account of the registered user.

At step 414, the issuer banking system server 40 validates the multi-character PIN of the registered user.

At step 414, the issuer banking system server 40 debits the financial account of the registered with the top-up amount and credits the top-up amount into a pool account upon successful validation. Thus, to enable UPI lite based payment transactions, funds are parked within the banking system server 40. In other words, upon receiving the load money request and successfully authenticating the registered user's PIN, the banking system server transfers funds from the registered user's account to a bank-owned pool account/virtual account.

At step 416, the issuer banking system server 40 sends a load money success response to the authentication engine 108 via the electronic switch 106, upon successfully crediting the pool account with the top-up amount.

At step 418, the authentication engine 108 updates the UPI lite account with a balance value based on the top-up amount and generates a first authorization response cryptogram (ARPC) and an update success response.

At step 420, the authentication engine 108 sends the first ARPC and the update success response to the PSP server 30 via the electronic switch 106.

At step 422, the PSP server 30 sends the first ARPC to the trusted application 104 via the PSP tool 20.

At step 424, the trusted application 104 verifies the received first ARPC and updates the balance value in the secure storage area of the electronic device 10 such that the balance value in the secure storage area matches with the balance value in the UPI lite account of the authentication engine 108. Thus, once the issuer banking system server 40 confirms the successful transfer of funds to the pool account, the UPI Lite service is enabled and the balance value is mirrored in the trusted application.

At step 426, the PSP tool 20 displays the updated balance value to the registered user via the PSP tool interface.

Exemplary pseudo codes of the PSP tool 20, the trusted application, the authentication engine 108, and the issuer banking system server 40 are as follows—

```
PSP tool -
Read (multi-character PIN and the top-up amount);
Do
  {
  Send the received top-up amount and multi-character PIN to the trusted application;
  Receive the first and second credential blocks from the trusted application;
  Generate and send a load money request to the authentication engine;
  Receive the first ARPC from the PSP server and send the received first ARPC to the
  trusted application;
  }
Trusted application or common library -
Do
  {
  Receive the top-up amount and multi-character PIN;
  perform a first-level verification of the registered user;
  perform a plurality of pre-defined checks and generate corresponding results;
  If (results == satisfactory)
    {
    create a first credential block comprising the multi-character PIN; create a
    second credential block comprising a first authorization request cryptogram
    (ARQC);
    send the generated credential blocks to the PSP tool;
    }
  Receive the first ARPC from the PSP tool;
  Verify the received first ARPC;
  Update the balance value in the secure storage area of the electronic device to match
  with the balance value in the UPI lite account of the authentication engine;
  }
Issuer banking system server -
Do
  {
  Receive the load money request via the electronic switch;
  validate the multi-character PIN of the registered user;
  If (validation status == success)
    {
    debit the financial account of the registered with the top-up amount and credit
    the top-up amount into a pool account upon successful validation;
    if (debit and credit == successful)
      {
      send a load money success response to the authentication
      engine;
      }
    }
  }
Authentication Engine -
Do
  {
  Receive the load money request;
  Validate the first ARQC;
  Receive the load money status;
  If (load money status == Success)
    {
    update the UPI lite account with a balance value based on the top-up amount;
    generate a first authorization response cryptogram (ARPC) and an update
    success response;
    send the first ARPC to the PSP tool via the PSP server and the electronic
    switch;
    }
  }
```

The load money transaction fails when the issuer banking system server 40 declines the transaction for the registered user's account debit failure or the pool account credit failure. In this case, the issuer banking system server 40 can be configured to send a respective response code to the electronic switch 106. The electronic switch 106 can initiate a request to the authentication engine 108 and fetch the first ARPC. The electronic switch 106 can then forward the same to the PSP server 30. The PSP server 30 forwards the response to the PSP tool 20 for updating the trusted application 104.

The load money transaction can further fail when there is debit timeout at the issuer banking system server 40. In this case, the electronic switch 106 initiates request to the authentication engine 108 for the first ARPC. The electronic switch 106 forwards the first ARPC in the final response to the PSP server 30. The PSP server 30 sends the same to the PSP tool 20 for updating the trusted application 104. The transactions are settled in the back office accordingly.

The load money transaction further fails when there is a message drop between the PSP server 30 and the electronic switch 106, thereby hampering the transmission of the first ARPC and the update success response to the PSP server 30. In this case, the PSP server 30 initiates synchronization between the trusted application 104 and the authentication engine 108.

The trusted application 104 stores the balance value and the pre-defined criteria in the secured storage area 102 for facilitating low ticket transactions. The balance value is maintained at the trusted application level, and the issuer banking system server 40 is responsible for topping up the balance value. The balance value is encrypted using the private encryption key generated within the secured storage area 102 by the trusted application 104. The registered users can utilize using this balance value to make payments within a fraction of second without requiring any PIN and by using mobile/PSP tool unlock PIN only. This will reduce the load on issuer servers 40 and the electronic switch 106 and help the registered users to perform small value transactions without exposing online PIN and the balance available in the central banking system.

The authentication engine 108 facilitates synchronization between the balance value in the secured storage area 102 of the electronic device 10 and the balance value in the authentication engine 108 at all times.

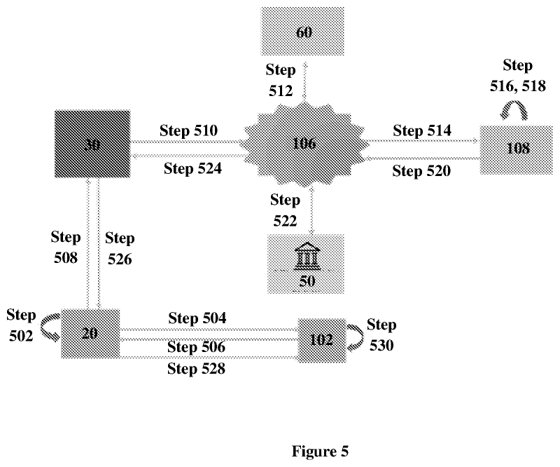

In an embodiment, referring to FIG. 5, the step of enabling the registered user to utilize the balance value 204c for performing the partially online transactions without hitting the banking system servers (40,50) comprises the following steps: At step 502, the PSP tool 20 enables the registered user to initiate a payment transaction, wherein the payment transaction is initiated by the registered user by providing transaction details. The transaction details include a payee's global identifier and a transaction amount.

The transaction may be initiated by scanning a static QR and entering the transaction amount, scanning a dynamic QR code which includes the transaction amount, by manually entering the global address/VPA of the payee and the transaction amount on the PSP tool interface, or by obtaining payees global identifier and transaction amount details via NFC from a merchant's terminal.

At step 504, the PSP tool 20 triggers the trusted application 104, upon payment transaction initiation. This causes the trusted application 104 to generate and return, at step 506, a second ARQC after performing a plurality of pre-defined checks, the second ARQC comprising the transaction details and the balance value extracted from the secure storage area of the electronic device. In the second ARQC, the transaction details and the balance value may be encrypted with a random AES key, wherein the AES key is encrypted with the private key (Ps). The transaction information comprises the payee's global identifier, the payer/registered user's global identifier, the transaction amount, and the results of the plurality of the pre-defined checks. For example, the pre-defined checks performed by the trusted application 104 include checking if the transaction is eligible for the partially online transaction by comparing the transaction amount with the balance value stored in the secured storage area 102 and/or comparing the transaction amount with the maximum allowable transaction amount for partially online transaction. A transaction is eligible for the partially online transaction if the transaction amount is less than the balance value stored in the secured storage area 102 and further the transaction amount is less than the maximum allowable transaction amount.

At step 508, the PSP tool 20 sends the second ARQC to the PSP server 30.

At step 510, the PSP server 30 initiates a payment request to the electronic switch 106 upon receiving the second ARQC.

At step 512, the electronic switch 106 initiates a global identifier translation request to the payee PSP server 60 of the payment transaction to obtain financial account details of the payee. The payee PSP server 60 is identified from the payee's global identifier.

At step 514, the electronic switch 106 initiates a validation request to the authentication engine 108 by sending the second ARQC to the authentication engine 108.

At step 516, the authentication engine 108 validates the second ARQC. The validation involves validating the second ARQC using the digital certificate corresponding to the registered user. This involves decrypting the ARQC using the pre-stored public key (Pk) corresponding to the registered user and matching the decrypted block (containing AES encrypted transaction information and results of the parameter checks) with the details stored in the authentication engine 108.

At step 518, the authentication engine 108 debits the transaction amount from the balance value on successful validation and generates a second ARPC in response.

At step 520, the authentication engine 108 sends the generated second ARPC to the electronic switch 106.

At step 522, the electronic switch 106 initiates a credit request to the payee's banking system server 50 based on the translated global identifier.

At step 524, the electronic switch 106 sends a credit success response along with the second ARPC to the payer's PSP server 30 upon successfully crediting the payee account with the transaction amount.

At step 526, the PSP server 30 sends the credit success response with the second ARPC to the PSP tool 20.

At step 528, the PSP server 30 sends the credit success response and the ARPC to the trusted application 104.

At step 530, the trusted application 104 updates the balance value stored in the secure storage area based on the ARPC.

Exemplary pseudo codes depicting the functions of the PSP tool 20, the trusted application 104, the electronic switch 106, and the authentication engine 108 are as follows—

```
PSP tool -
Do
  {
  Receive transaction details from the registered user;
  Trigger the trusted application to generate and return a second ARQC;
  PSP tool sends the second ARQC to the electronic switch via the PSP server;
  }
Electronic switch -
Do
  {
  Receive the second ARQC;
  Initiate a global identifier translation request to the payee PSP server to obtain
  financial account details of the payee;
  Initiate a validation request to the authentication engine by sending the second ARQC
  thereto;
  If (second ARPC is received == Yes)
    {
    Initiate a credit request to the payee's banking system server;
    If (credit is successful == Yes)
      {
      send a credit success response along with the second ARPC to the PSP
      tool via the payer's PSP server;
      }
    }
  }
Trusted application or common library -
Do
  {
  Receive a trigger from the PSP tool to generate and return a second ARQC;
  Perform a plurality of pre-defined checks;
    If (results of the checks == Satisfactory)
        {
        Generate and return the second ARQC;
        }
  Receive the credit success response and the second ARPC from the PSP tool;
  Update the balance value in the secure storage area based on the second ARPC;
  }
Authentication Engine -
Do
  {
  Validate the second ARQC;
  Debit the transaction amount from the balance value;
  If (debit == successful)
    {
    Generate a second ARPC in response;
    Send the generated second ARPC to the electronic switch;
    }
```

The balance value available in the secured storage area 102 will be the first decision point for the trusted application 104 to decide whether or not to carry out the partially online transaction.

In case, the balance value does not get updated due to network connectivity, it will get updated when the electronic device 10 is online or when a subsequent transaction happens. The authentication engine 108 decides whether the transaction should be a fully online or a partially online transaction based on the available balance value. The fully online transaction may be carried out in the conventional manner by retrieving the PIN from the user and performing PIN validation at the issuer server 40.

In summary, the partially online transactions are initiated by the registered users by scanning a static/dynamic QR code or by tapping the electronic device 10 at a merchant terminal to carry out a scan and pay/NFC based transactions to consume the balance value against the purchase of goods. The partially online transaction is a transaction that is done using the balance value and approved by the proxy issuer i.e. authentication engine 108, based on stored balance value and required authentication criteria.

In an embodiment, the partially online transaction fails when—
a) the credit request is declined by the payee's banking system server: In this case, the electronic switch 106 can initiate a debit reversal to the authentication engine 108. A new second ARPC can be generated by the authentication engine 108 and sent to the PSP server 30. The PSP server 30 can facilitate updating of the trusted application 104 for the transaction failure.
b) there is deemed transaction by the payee's banking system server.
c) there is a message drop between the PSP server 30 and the electronic switch 106, thereby hampering the transmission of the credit success response along with the second ARPC to the PSP server: In this case, the PSP server 30 can initiate a synchronization to the electronic switch 106, the electronic switch 106 can fetch the second ARPC with the last status update at the authentication engine 108, and the PSP server 30 can use this ARPC to update the trusted application 104 with the final status.
d) the registered user's PSP server 30 fails to send the credit success response with the second ARPC to the PSP tool 20: In this case, the PSP server 30 can re-try till the second ARPC is shared successfully to the PSP tool 20; In case, the PSP server 30 fails to store the second ARPC, the PSP server 30 can invoke the PSP tool 20 to initiate a synchronization to fetch the second ARPC again from the electronic switch 106.
e) the PSP tool 20 fails to send the credit success response with the second ARPC to the trusted application: In this case, the PSP tool 20 re-tries till the trusted application 104 gets updated.

In an embodiment, the step of enabling the registered user to utilize the balance value 204c for performing the offline transaction comprises the following steps. First, the PSP tool 20 enables the registered user to initiate an offline payment transaction, wherein the offline payment transaction is initiated by the registered user by establishing a communication channel between the electronic device 10 and a payee device to obtain the transaction details. The transaction details include a payee's global identifier and a transaction amount. Thereafter, the trusted application 104 generates an offline signature using an offline data authentication technique (ODA). The ODA technique used herein can be a standard offline authentication technique. The offline signature may be created over a dynamic data string comprising parameters such as transaction amount, transaction identifier, transaction time stamp, payer lite account number, payee global address, mobile number of the payer/registered user, and device identifier. The trusted application 104 sends the generated offline signature and the pre-stored digital certificate to the PSP tool 20. The PSP tool 20 sends the offline signature to the payee device and the PSP server 30. The payee device and the PSP server 30 authenticates the PSP tool 20 based on the available balance value in the secured storage area 102, the offline signature, and the digital certificate. The PSP tool 20 debits the required amount from the balance value post successful authentication. The payee device sends an advice to the authentication engine 108 to update the balance value.

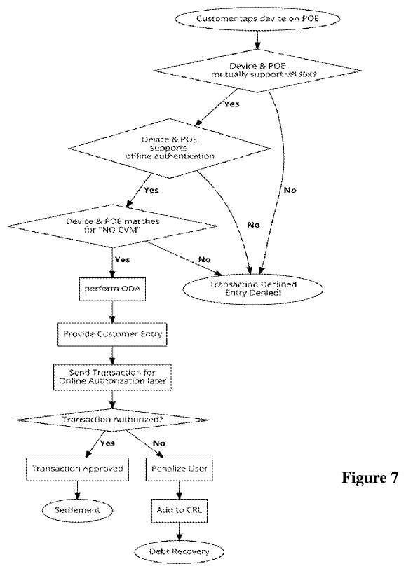

In an exemplary embodiment, referring to FIG. 7, for carrying out an offline transaction, a registered user opens the PSP tool 20 on his/her electronic device 10 and selects the ‘Tap and Pay’ option. With ‘Tap and pay’ on the screen, the registered user taps the electronic device 10 onto a merchant terminal to initiate the transaction. The transaction is thus initiated using an NFC channel between the electronic device 10 and the merchant terminal. Based on the available balance value in the secured storage area 102 and the mutually supported offline data authentication (ODA) method, the merchant terminal authenticates the PSP tool 20 and requests for approval of the transaction. The terminal and the PSP tool 20 determine which ODA method is supported, following which the terminal requests the PSP tool 20 to generate a digital signature using the supported ODA method. Depending on the method used, the ODA can ensure that the PSP tool 20 and the trusted application 104 is genuine and that the key transaction information has not been modified during transmission. Post successful authentication, the PSP tool 20 debits the required amount from the balance value and approves the transaction. A standard device verification method can be used for the verification of the registered user. Post successful transaction, the terminal sends an advice to the authentication engine 108 to update the balance value and the pre-defined parameters.

During the offline transaction, there can be two failure scenarios—
issue with the electronic device 10 during the transaction—In this case, the transaction amount will not be deduced from the balance value of the registered user.
issue with the electronic device 10 after transaction completion—If any party comes online, the balance value gets validated and realized after processing transaction and thereafter, the registered user will able to use it for future transactions. Until synchronization with the authentication engine, 108 is done online, the balance value cannot be used for any transactions.

In an embodiment, the PSP tool 20 provides an option for the registered user to opt out of the UPI account. On confirmation, 1-click device verification is done by the authentication engine 108, and de-registration is done by deactivating the user's UPI lite account and removing the public-private keys.

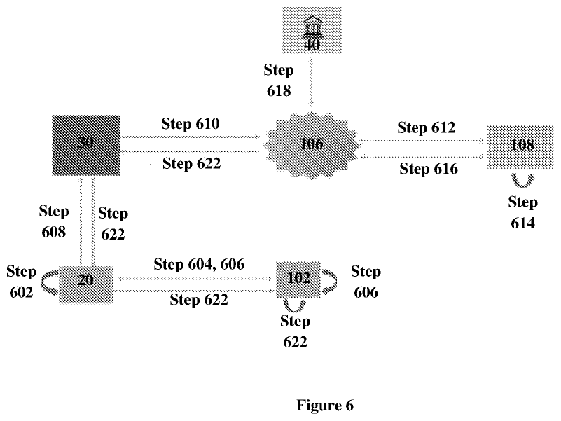

Referring to FIG. 6, the method 200 comprises the step of enabling, by the PSP tool 20, the registered user to disable the UPI lite account. The step comprises the following sub-steps—At step 602, the PSP tool 20 enables the registered user to initiate the disablement of the UPI lite account.

At step 604, the PSP tool 20 triggers the trusted application 104 upon initiation of disablement. This causes the trusted application 104, at step 606, to generate and return a third ARQC after performing a plurality of pre-defined checks. The third ARQC comprises the registered user's financial account details under payee and the registered user's lite account number under payer.

At step 608, the PSP tool 20 sends the third ARQC to the PSP server 30.

At step 610, the PSP server 30 initiates a payment request to the electronic switch 106 upon receiving the third ARQC. The payment request comprises the third ARQC.

At step 612, the electronic switch 106 forwards the payment request to the authentication engine 108.

At step 614, the authentication engine 108 validates the received third ARQC and debits the balance value on successful validation and generates a third ARPC in response.

At step 616, the authentication engine 108 sends the generated third ARPC to the electronic switch 106.

At step 618, the electronic switch 106 sends a credit request to the issuer banking system server 40 to credit the financial account of the registered user with the balance value.

At step 620, the electronic switch 106 receives a credit success response from the issuer banking system server 40 and forwards the credit success response and the third ARPC to the PSP server 30.

At step 622, the PSP server 30 sends the credit success response and the third ARPC to the trusted application 104 via the PSP tool 20.

At step 624, the trusted application 104 clears the balance value stored in the secure storage area upon receiving the third ARPC.

In an embodiment, the step of disabling the UPI lite account fails when—(i) there is a timeout at the issuer banking system server 40, (ii) decline by the issuer banking system server 40, and/or (iii) there is a message drop between the PSP server 30 and the electronic switch 106, thereby hampering the transmission of the third ARPC and the credit success response to the PSP server 30.

The PSP tool 20 facilitates the registered user to retrieve a UPI lite account without requiring the multi-character PIN from the user. If the PSP tool 20 does not know if a registered user has a UPI lite account, it may enable the registered user to add the financial account. However, in this case, the registered user may be prompted to enter the PIN for verification at the issuer banking system server 40.

In a further embodiment, the PSP tool 20 enables the registered user to check the balance associated with the UPI lite account. The balance inquiry transaction will be a self-triggered transaction in which the authentication engine 108 will synchronize its balance with the balanced value stored in the secured storage area 102 of the electronic device 10. In this transaction, the trusted application 104 will generate an authorization request cryptogram (ARQC) with zero as an input to those elements which are related to purchase transaction.

The trusted application 104 supports layered tamper detection and response mechanisms. The trusted application 104 enforces access control mechanisms to ensure that the trusted application 104 data is not accessible by another mobile application. The trusted application 104 can also provide a channel that supports and protects communication with external systems.

The trusted application 104 can be integrated with one or more third party applications as an SDK and supports API based integration to deliver updates in the business processes. It has a secure update mechanism to allow integrity of the software applications to be verified when they are uploaded to the kernel.

The trusted application 104 is made available to only those users whose electronic devices 10 support the secured storage area 102. The secured storage area 102 is implemented either in software or hardware, or a combination of software and hardware (such as a Secure element or TEE). Possible implementations of such solutions include:
Using a trustlet running in a Trusted Execution Environment to encrypt and manage all security sensitive data and/or to host a payment kernel;
Using an applet running in a hardware-based Secure Element to encrypt and manage all security sensitive data and/or to host a payment kernel; and
Using a combination of a device specific hardware capability, such as Android Key Store, to implement secure storage and software methods to encrypt and manage all security-sensitive data.

The secured storage area 102 can have two functions: (i) to support secure cryptographic algorithm execution without exposing the key material, and (ii) to ensure sensitive data remains in encrypted form when stored on a handset.

The plurality of pre-defined checks disclosed herein comprise one or more of the following:
a determination as to whether the electronic device is rooted or not;
a determination as to whether the electronic device supports the secure storage area or not;
a determination as to whether or not the key attestation is valid;
a determination as to whether or not one or more transaction parameters satisfy one or more pre-defined criteria.

The transaction parameters are selected from the group consisting of the balance value, a count of the partially online transactions, a count of offline transactions, the transaction amount associated with the partially online transaction, the transaction amount associated with the offline transaction, a total amount associated with the partially online transactions, and a total amount associated with the offline transactions. Further, the determination as to whether or not one or more transaction parameters satisfy the one or more pre-defined criteria include determining:
whether the transaction amount is less than or equal to a maximum value of the transaction amount for a partially online transaction;
whether the transaction amount is less than or equal to a maximum value of the transaction amount for an offline transaction;
whether the transaction amount is less than or equal to the balance value in the UPI lite account;
whether a count of the partially online transaction is less than a pre-defined online transaction count limit;
whether a count of the offline transaction is less than a pre-defined offline transaction count limit;
whether the count of the offline transaction is less than or equal to a maximum number of offline consecutive transactions that are allowed; and
whether a total amount of offline transactions is less than or equal to a pre-defined maximum offline transaction amount limit.

The first, second, and the third ARQC disclosed herein include one or more of the following:
the public key of the device 10 stored in the secured storage area 102;
a transaction block comprising one or more of the transaction parameters encrypted with a random AES key, the transaction block being further encrypted with the private key that resides in the secure storage area, the transaction parameters comprising, but not limited to, one or more of the following information:
   transaction details comprising the transaction amount or top-up amount, transaction date, transaction time, and payee global identifier, and the UPI lite account number;
   a random number;
   customer verification result;
   balance value; and
   transaction counter, Public Key exponent (asymmetric), transaction type, and balance limit.

The trusted application 104 is device-binding and is defined based on the parameters selected from the group consisting of an application identifier, a device identifier of the registered user, mobile number of the registered user, IFSC of the issuer banking system server 40, and the financial account number.

Further, when there is a device change, the PSP server 30 initiates the key list request with a new device identifier value. The records stored by the authentication engine 108 for the registered user will be updated. In case the registered user uninstalls a PSP tool 20 and the PSP server 30 needs to retrieve the lite service details, the PSP server 30 fires the key list request to fetch the lite service number/unique lite account number followed by a synchronization call for the lite status.

Advantageously, the PSP tool 20 is configured to detect a tamper event and is further configured to cause the automatic and immediate erasure of the information contained in the PSP tool 20 upon detection of the tamper event.

In an embodiment, if the authentication engine 108 finds that a registered user is involved in a potential fraud or if a genuine customer calls the issuer and reports their electronic device 10 lost, the authentication engine 108 adds the entry of the registered user's certificate in a Certificate Revocation List (CRL). Also, the authentication engine 108 restrains from issuing a new Device Certificate to the user in case they are found in this list.

In case the registered user deletes the PSP tool 20 or the device identifier (ID) changes and upon registration of the same registered user on the same device or another device, there will be a provision to reclaim the balance. The PSP tool 20 will trigger a registration request basis on a pre-defined purpose code. The system 100 checks the UPI lite services against the mobile number on the given PSP tool 20. If there is a balance associated with lite service.

The information pertaining to the reclaim transaction will be sent to the issuer banking system server 40.

Like the original online UPI transactions, the UPI lite is also interoperable, meaning the registered can transfer funds using the UPI lite account to any bank account.

To avoid a major risk of multiple offline transactions, the authentication engine 108 can be configured to communicate with merchant terminals to facilitate the merchant terminals to maintain a Deny List. The Deny List can be updated periodically according to the Certificate Revocation List (CRL) published by the authentication engine 108. Thus, the system 100 allows the registered users to perform only a pre-defined number of offline transactions.

Advantageously, the PSP server 30 is configured to provide the unique reference number to each of the account numbers of each of the registered users. The PSP server 30 ensures that for the same financial account of a registered user, the unique reference should be always the same.

Advantageously, the trusted application 104 comprises a deletion module. The PSP tool 20 is configured to trigger the logout module when a logout intent is received from the registered user. Upon receiving logout intent, the logout module is configured to delete the Private Key from the secured storage area 102 of the electronic device 10.

Advantageously, all the UPI lite transactions are validated by the authentication engine 108 by means of cryptogram validation (ARPC/ARQC). The trusted application 104 is configured to disallow transactions to process via the UPI lite account if it does not receive the ARPC (response cryptogram) from the authentication engine 108. If the ARPC is not received by the trusted application 104 for a transaction where ARQC is generated, the PSP tool 20 will temporarily halt/suspend all the UPI lite transactions until ARPC is received from the UPI Lite engine. The PSP server 30 shall initiate a synchronization with the authentication engine 108 to obtain an updated ARPC which will allow the trusted application 104 to synchronize with the authentication engine 108. Further, if there is a timeout before the transaction is authenticated by the authentication engine 108, the PSP tool 20 will have an option to synchronize the balance with the authentication engine 108 and restore the balance for the transaction which has been initiated.

In case of timeouts, the PSP tool 20 can be configured to initiate a check transaction request to synchronize up with the authentication engine 108. The ARPC will contain the last updated status of the authentication engine 108 and that will enable the trusted application 104 to synchronize with the authentication engine 108. If the authentication engine 108 is unable to provide a synchronization update to the PSP tool 20, the lite services will be temporarily blocked until a successful synchronization is done. A successful synchronization implies that the authentication engine 108 has provided a valid ARPC to the PSP tool 20 and the trusted application 104 has acknowledged the same.

To enable the banking system servers (40,50) to perform reconciliation for the UPI lite transactions, the authentication engine 108 can be configured to provide a file containing detailed transactions data of the lite transactions to the issuer banking system server 40 and the balance value at the time of settlement generation. The banking system server 40 will debit funds from the respective user's lite service pool/virtual account. Thereafter, the banking system server 40 will match the balance value of the registered user (post debiting the pool/virtual account) with the balance value provided by the authentication engine 108. If the balance matches, the reconciliation is successful.

In an exemplary embodiment, to facilitate partially online and offline transactions, the PSP tool 20 can be configured to perform multiple checks such as—validating from the trusted application 104 if transaction amount is available to process the transaction, validating based on the amount entered by the user if the amount is eligible for lite transactions, initiating synchronization in the event ARPC is not received for any lite transaction where ARQC has been initiated, in the event no response is received to the synchronization request, after a pre-defined period of time and a pre-defined number of synchronization attempts, processing the transactions via the fully online transaction flow (with two-factor authentication), prompting the registered user with notification to top up in the event the balance value is below a pre-defined amount (e.g., Rs. 200), ensuring that the top-up amount does not exceed a pre-set amount (e.g., Rs. 2000) based on the balance value available on the secure storage area 102, obtaining customer consent for enabling the lite services before initiating enablement flow, and initiating the automated disable lite services if the registered user has not performed any financial transaction for a pre-defined period of time (in case user has discarded device/account closure).

Similarly, the trusted application 104 can be configured to keep a check on the ARPC received from previous transactions. If the same has not been received, the trusted application 104 will not initiate ARQC for the subsequent transactions.

To replace PIN-based authentication and reduce the dependence on issuer central banking servers, the present disclosure provides a form of authentication that leverages Public Key Infrastructure (PKI) and hardware-backed secure storage on consumer devices, suitable for low-value transactions. A secret key (Ps) or private key, unique to the user's bank account, is securely stored on the device 10 and serves to strongly authenticate low-value transactions. The secure key is stored in Hardware-backed Cryptographic Vault (HbCV) (Secure Element or TEE or Strongbox Keystore, as available) on the verified consumer' device 10. Since the requirement for PIN verification is eliminated for low value transactions, the transaction failures due to technical decline (TD) and business decline (BD), for e.g., due to invalid multi-character PIN and insufficient funds are drastically reduced. This improves the overall success rate of low value transactions. In particular, for every instance the registered user adds funds of Rs. 2000 to the UPI lite account, approximately 28-33 transactions below Rs. 200 are avoided on the banking system infrastructure. The technical declines for UPI Lite related financial transactions are eliminated as the hop to issuer banking system server is prevented. Due to this, the success rates are improved by approximately 5%.

The present disclosure further envisages the configurable solution of balance value that complements any type of digital payment service regardless of settlement rail, e.g. QR based instant payment or closed-loop store value etc. The balance value may be facilitated in multiple ways, e.g. by pre-authorization, sub-store values for issuers, or credit. The transaction may be communicated using any type of proximity interaction, e.g. Dynamic QR, NFC, Bluetooth, or Sound and the merchant can verify the Payment, with a mobile app, a PC, or any device. The trusted application 104 of the present invention supports techniques to process smart rules in synchronization with the electronic switch 106 as well as techniques for verifying the state of one or more applications on the mobile device 10 trying to perform non-expected functions of the trusted execution environment and also migrating the state of the application from a trusted execution environment from a first mobile device 10 to a second mobile device 10 in the case the mobile device 10 is compromised, lost, stolen damaged or being upgraded.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

The foregoing description of the embodiments has been provided for purposes of illustration and not intended to limit the scope of the present disclosure. Individual components of a particular embodiment are generally not limited to that particular embodiment, but are interchangeable. Such variations are not to be regarded as a departure from the present disclosure, and all such modifications are considered to be within the scope of the present disclosure.

### Technical Advancements

The present disclosure described herein above has several technical advantages including, but not limited to, the realization of a system and method that:
facilitate rule-based partially online and offline payment transactions;
facilitate payment transactions without requiring the users to expose sensitive information such as PIN or password;
that reduce the payment processing load on issuer switch, payment service providers, and bank servers;
facilitate rule-based, small value transactions without hitting the bank servers;
facilitate payment transactions to be carried out in a secured manner;
aid in scaling transaction processing with minimal infrastructure cost;
ensure settlement of funds in a systematic manner;
reduce transaction failures due to technical decline (TD) and business decline (BD), for e.g., due to invalid multi-character PIN and insufficient funds, and improve the overall success rate of low value transactions; and
enable registered users to carry out single-click payment transactions.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A method (200) for facilitating registered users to perform rule-based partially online and offline payment transactions, each of the registered users having one or more payment service provider (PSP) tools (20) installed on their electronic devices (10), each PSP tool (20) hosted by a PSP server (30), the registered users having a financial account linked with a unique multi-character PIN and a global identifier, said method (200) comprising:
executing (202), by a PSP tool (20) installed in an electronic device (10) associated with a registered user, a trusted application (104) in a secured storage area of the electronic device (10);
enabling (204), via a central electronic switch (106), the trusted application (104), the PSP tool (20), and the PSP server (30) to communicate with an authentication engine (108) and a plurality of banking system servers (40,50) to enable the registered user to:
enroll and create (204a) a Unified payments Interface (UPI) lite account for performing the rule-based partially online and offline payment transactions;
load money (204b) into the created UPI lite account from a registered financial account, wherein the value of money loaded into the UPI lite account is stored as a balance value in the secured storage area; and
utilize the balance value (204c) for performing the partially online and offline payment transactions without hitting the banking system servers (40,50).

2. The method (200) as claimed in claim 1, wherein the step of enabling the registered user to enroll and create (204a) the UPI lite account for performing the rule-based partially online and offline payment transactions comprises:
i. receiving (302), by the PSP tool (20), a service enablement command from the registered user via the PSP tool interface, the service enablement command comprising the details of a financial account to be enabled for performing partially online and offline transactions;
ii. generating (304), by the PSP tool (20), a request for fetching public key upon receiving the service enablement command and sending the generated public key fetching request to the trusted application (104);
iii. generating (306), by the trusted application (104), a private(Ps)-public(Pk) key pair within the secure storage area of the electronic device (10) upon receiving the public key fetching request from the PSP tool (20);
iv. sending (308), by the trusted application (104), the public key from the generated private-public key pair to the PSP tool (20);
v. generating (310), by the PSP tool (20), a key list request upon receiving the public key, the key list request comprising the public key;
vi. transmitting (312), by the PSP tool (20), the generated key list request to the electronic switch (106) via the PSP server (30) associated with the PSP tool (20);
vii. routing (314), by the electronic switch (106), the key list request received from the PSP server (30) to the authentication engine (108);
viii. opening (316), by the authentication engine (108), the UPI lite account for the registered user by generating a Digital Certificate(DC-Pk) using the public key and updating a service enablement record with a unique lite account number, wherein the Digital-certificate(Pk) and the public key are stored by the authentication engine (108) for authenticating future partially online or offline transactions initiated from the electronic device (10);
ix. generating (318), by the authentication engine (108), a key list success response upon successfully opening the UPI lite account and storing the public key; and
x. communicating (320), by the authentication engine (108), the key list success response to the PSP tool (20) via the electronic switch (106) and the PSP server (30) to notify the registered user about the service enablement success for the respective financial account.

3. The method (200) as claimed in claim 1, wherein the step of enabling the registered user to load money (204b) into the created UPI lite account from the registered financial account comprises:
i. generating (402), by the PSP tool (20), a PIN and amount entry prompt on the PSP tool interface, to retrieve the multi-character PIN and a top-up amount from the registered user to load the amount into the created UPI lite account;
ii. receiving (402), by the PSP tool, the multi-character PIN, and the top-up amount via the PSP tool interface;
iii. prompting (402), by the trusted application (104), the registered user to perform a first-level verification by implementing a device fingerprint scan;
iv. creating (404), by the trusted application (104), a first credential block comprising the multi-character PIN, and a second credential block comprising a first authorization request cryptogram (ARQC) after performing a plurality of pre-defined checks;
v. receiving (404), by the PSP tool (20), the generated first and second credential blocks from the trusted application (104);
vi. initiating (406), by the PSP tool (20), a load money request to the PSP server (30), the load money request comprising the first and second credential blocks;
vii. sending (408), by the PSP server (30), the load money request to the authentication engine (108) via the electronic switch (106);
viii. validating (410), by the authentication engine (108), the service enablement record, and the first ARQC, upon receiving the load money request;
ix. forwarding (412), by the electronic switch (106), the load money request to an issuer banking system server (40) associated with the financial account of the registered user;
x. validating (414), by the issuer banking system server (40), the multi-character PIN of the registered user;
xi. debiting (414), by the issuer banking system server (40), the financial account of the registered with the top-up amount, and crediting the top-up amount into a pool account upon successful validation;
xii. sending (416), by the issuer banking system server (40), a load money success response to the authentication engine (108) via the electronic switch (106), upon successfully crediting the pool account with the top-up amount;
xiii. updating (418), by the authentication engine (108), the UPI lite account with a balance value based on the top-up amount and generating a first authorization response cryptogram (ARPC) and an update success response;
xiv. sending (420), by the authentication engine (108), the first ARPC and the update success response to the PSP server (30) via the electronic switch (106);
xv. sending (422), by the PSP server (30), the first ARPC to the trusted application (104) via the PSP tool (20);
xvi. verifying and updating (424), by the trusted application (104), the balance value in the secure storage area of the electronic device (10); and
xvii. displaying (426), by the PSP tool (20), the updated balance value to the registered user via the PSP tool interface.

4. The method (200) as claimed in claim 1, wherein the step of enabling the registered user to utilize the balance value (204c) for performing the partially online transactions without hitting the banking system servers (40,50) comprises:
i. enabling (502), by the PSP tool (20), the registered user to initiate a payment transaction, wherein the payment transaction is initiated by the registered user by providing transaction details, the transaction details including a payee's global identifier and a transaction amount;
ii. triggering (504), by the PSP tool (20), the trusted application (104) upon payment transaction initiation to cause the trusted application (104) to generate and return (506) a second ARQC after performing a plurality of pre-defined checks, the second ARQC comprising the transaction details and the balance value extracted from the secure storage area;
iii. sending (508), by the PSP tool (20), the second ARQC to the PSP server (30);
iv. initiating (510), by the PSP server (30), a payment request to the electronic switch (106) upon receiving the second ARQC;
v. initiating (512), by the electronic switch (106), a global identifier translation request to the payee PSP server (60) of the payment transaction to obtain financial account details of the payee;
vi. initiating (514), by the electronic switch (106), a validation request to the authentication engine (108) by sending the second ARQC to the authentication engine (108);
vii. validating (516), by the authentication engine (108), the second ARQC;
viii. debiting (518), by the authentication engine (108), the transaction amount from the balance value on successful validation and generating a second ARPC in response;
ix. sending (520), by the authentication engine (108), the generated second ARPC to the electronic switch (106);
x. initiating (522), by the electronic switch (106), a credit request to the payee's banking system server (50) based on the translated global identifier;
xi. sending (524), by the electronic switch (106), a credit success response along with the second ARPC to the payer's PSP server (30) upon successfully crediting the payee account with the transaction amount;
xii. sending (526), by the PSP server (30), the credit success response with the second ARPC to the PSP tool (20);
xiii. sending (528), by the PSP server (30), the credit success response and the ARPC to the trusted application (104); and
xiv. updating (530), by the trusted application (104), the balance value stored in the secure storage area based on the ARPC.

5. The method as claimed in claim 1, which further comprises the step of enabling, by the PSP tool (20), the registered user to disable the UPI lite account, said step comprising the following sub-steps:
i. enabling (602), by the PSP tool, the registered user to initiate the disablement of the UPI lite account;
ii. triggering (604), by the PSP tool (20), the trusted application (104) upon initiation of disablement to cause the trusted application (104) to generate and return (606) a third ARQC after performing a plurality of pre-defined checks, the third ARQC comprising the registered user's financial account details under payee and the registered user's lite account number under payer;
iii. sending (608), by the PSP tool (20), the third ARQC to the PSP server (30);
iv. initiating (610), by the PSP server (30), a payment request to the electronic switch (106) upon receiving the third ARQC, the payment request comprising the third ARQC;
v. forwarding (612), by the electronic switch (106), the payment request to the authentication engine (108);
vi. validating (614), by the authentication engine (108), the received ARQC;
vii. debiting (614), by the authentication engine (108), the balance value on successful validation and generating a third ARPC in response;
viii. sending (616), by the authentication engine (108), the generated third ARPC to the electronic switch (106);
ix. sending (618), by the electronic switch (106), a credit request to the issuer banking system server (40) to credit the financial account of the registered user with the balance value;
x. receiving (620), by the electronic switch (106), a credit success response from the issuer banking system server (40), and forwarding the credit success response and the third ARPC to the PSP server (30);
xi. sending (622), by the PSP server (30), the credit success response and the ARPC to the trusted application (104) via the PSP tool (20); and
xii. clearing (624), by the trusted application (104), the balance value stored in the secure storage area upon receiving the ARPC.

6. The method (200) as claimed in claim 3, wherein the step of loading money into the created UPI lite account from the registered financial account fails when:
i. the issuer banking system server (40) declines the transaction for the registered user's account debit failure or the pool account credit failure;
ii. there is a debit timeout at the issuer banking system server (40); and
iii. there is a message drop between the PSP server (30) and the electronic switch (106), thereby hampering the transmission of the first ARPC and the update success response to the PSP server (30).

7. The method (200) as claimed in claim 5, wherein the step of disabling the UPI lite account fails when:
i. there is a timeout at the issuer banking system server (40);
ii. decline by the issuer banking system server (40); and
iii. there is a message drop between the PSP server (30) and the electronic switch (106), thereby hampering the transmission of the third ARPC and the credit success response to the PSP server (30).

8. The method (200) as claimed in claim 4, wherein the partially online transaction fails when:
i. the credit request is declined by the payee's banking system server (50);
ii. there is deemed transaction by the payee's banking system server (50);
iii. there is a message drop between the PSP server (30) and the electronic switch (106), thereby hampering the transmission of the credit success response along with the second ARPC to the PSP server (30);
iv. the registered user's PSP server (30) fails to send the credit success response with the second ARPC to the PSP tool (20); and
v. the PSP tool (20) fails to send the credit success response with the second ARPC to the trusted application (104).

9. The method (200) as claimed in claim 1, wherein the step of enabling the registered user to utilize the balance value (204c) for performing the offline transaction comprises:
i. enabling, by the PSP tool (20), the registered user to initiate an offline payment transaction, wherein the offline payment transaction is initiated by the registered user by establishing a communication channel between the electronic device (10) and a payee device to obtain the transaction details, the transaction details including a payee's global identifier and a transaction amount;
ii. generating, by the trusted application (104), an offline signature using an offline data authentication technique (ODA); and
iii. sending, by the trusted application (104), the generated offline signature along with the digital certificate to the PSP tool (20);
iv. sending, by the PSP tool (20), the offline signature and the digital certificate to the payee device;
v. authenticating, by the payee device, the PSP tool (20) based on the available balance value in the secured storage area (102), the offline signature, and the digital certificate;
vi. debiting, by the PSP tool (20), the required amount from the balance value post successful authentication; and
vii. sending, by the payee device, an advice to the authentication engine (108) to update the balance value.

10. The method as claimed in claim 1, wherein the plurality of pre-defined checks includes one or more of the following:
i. a determination as to whether the electronic device is rooted or not;
ii. a determination as to whether the electronic device supports the secure storage area or not;
iii. a determination as to whether or not the key attestation is valid; and
iv. a determination as to whether or not one or more transaction parameters satisfy one or more pre-defined criteria.

11. The method (200) as claimed in claim 10, wherein the transaction parameters are selected from the group consisting of the balance value, a count of the partially online transactions, a count of offline transactions, the transaction amount associated with the partially online transaction, the transaction amount associated with the offline transaction, a total amount associated with the partially online transactions, and a total amount associated with the offline transactions.

12. The method (200) as claimed in claim 10, wherein the determination as to whether or not one or more transaction parameters satisfy the one or more pre-defined criteria include:
i. whether the transaction amount is less than or equal to a maximum value of the transaction amount for a partially online transaction;
ii. whether the transaction amount is less than or equal to a maximum value of the transaction amount for an offline transaction;
iii. whether the transaction amount is less than or equal to the balance value in the UPI lite account;
iv. whether a count of the partially online transaction is less than a pre-defined online transaction count limit;
v. whether a count of the offline transaction is less than a pre-defined offline transaction count limit;
vi. whether the count of the offline transaction is less than or equal to a maximum number of offline consecutive transactions that are allowed; and
vii. whether a total amount of offline transactions is less than or equal to a pre-defined maximum offline transaction amount limit.

13. The method as claimed in claim 3, wherein the first ARQC include one or more of the following:
i. the public key of the device stored in the secured storage area (102);
ii. a transaction block comprising one or more of the transaction parameters encrypted with a random AES key, the transaction block being further encrypted with another AES key that resides in the secure storage area, the transaction parameters comprising one or more of the following information:
transaction details comprising the transaction amount or top-up amount, transaction date, transaction time, and payee global identifier, and the UPI lite account number;
a random number;
customer verification result;
balance value; and
transaction counter, Public Key exponent (asymmetric), transaction type, and balance limit.

14. The method as claimed in claim 1, wherein the trusted application is device-binding and is defined based on the parameters selected from the group consisting of an application identifier, a device identifier of the registered user, mobile number of the registered user, IFSC of the issuer banking system server (40), and the financial account number.

15. The method (200) as claimed in claim 1, wherein the PSP tool (20) is configured to detect a tamper event and is further configured to cause the automatic and immediate erasure of the information contained in the PSP tool (20) upon detection of the tamper event.

16. A system (100) for facilitating registered users to perform rule-based partially online and offline payment transactions, each of the registered users having one or more payment service provider (PSP) tools (20) installed on their electronic devices (10), each PSP tool (20) hosted by a PSP server (30), the registered users having a financial account linked with a unique multi-character PIN and a global identifier, said system (100) comprising:
a trusted application (104) executed, by a PSP tool (20) installed in an electronic device (10) associated with a registered user, in a secured storage area of the electronic device (10);
an authentication engine (108); and
a central electronic switch (106) configured to facilitate communication of the trusted application (104), the PSP tool (20), and the PSP server (30) with the authentication engine (108) and a plurality of banking system servers (40,50) to enable the registered user to:
enroll and create a UPI lite account for performing the rule-based partially online and offline payment transactions;
load money into the created UPI lite account from a registered financial account, wherein the value of money loaded into the UPI lite account is stored as a balance value in the secured storage area; and
utilize the balance value for performing the partially online and offline payment transactions without hitting the banking system servers (40,50).

17. The method as claimed in claim 2, wherein the plurality of pre-defined checks includes one or more of the following:
a determination as to whether the electronic device is rooted or not;
a determination as to whether the electronic device supports the secure storage area or not;
a determination as to whether or not the key attestation is valid; and
a determination as to whether or not one or more transaction parameters satisfy one or more pre-defined criteria.

18. The method as claimed in claim 3, wherein the plurality of pre-defined checks includes one or more of the following:
a determination as to whether the electronic device is rooted or not;
a determination as to whether the electronic device supports the secure storage area or not;
a determination as to whether or not the key attestation is valid; and
a determination as to whether or not one or more transaction parameters satisfy one or more pre-defined criteria.

19. The method as claimed in claim 4, wherein the second ARQC include one or more of the following:
i. the public key of the device stored in the secured storage area (102);
ii. a transaction block comprising one or more of the transaction parameters encrypted with a random AES key, the transaction block being further encrypted with another AES key that resides in the secure storage area, the transaction parameters comprising one or more of the following information:
transaction details comprising the transaction amount or top-up amount, transaction date, transaction time, and payee global identifier, and the UPI lite account number;
a random number;
customer verification result;
balance value; and
transaction counter, Public Key exponent (asymmetric), transaction type, and balance limit.

20. The method as claimed in claim 5, wherein the third ARQC include one or more of the following:
i. the public key of the device stored in the secured storage area (102);
ii. a transaction block comprising one or more of the transaction parameters encrypted with a random AES key, the transaction block being further encrypted with another AES key that resides in the secure storage area, the transaction parameters comprising one or more of the following information:
transaction details comprising the transaction amount or top-up amount, transaction date, transaction time, and payee global identifier, and the UPI lite account number;
a random number;
customer verification result;
balance value; and
transaction counter, Public Key exponent (asymmetric), transaction type, and balance limit.
